(19) United States
(12) Patent Application Publication
(10) Pub. No.: US 2004/0085260 A1
(43) Pub. Date: May 6, 2004

(54) Multi-lingual display apparatus and method

(76) Inventor: Louis C. McDavid III, Boston, MA (US)

Correspondence Address: AKC PATENTS, 215 GROVE ST., NEWTON, MA, 02466, US

(21) Appl. No.: 10/341,053

(22) Filed: Jan. 13, 2003

Related U.S. Application Data
(60) Provisional application No. 60/424,036, filed on Nov. 5, 2002.

(51) Int. Cl. G09G 5/00

(52) U.S. Cl. 345/7

(57) ABSTRACT

A multi-lingual display system includes at least a first image containing text written in a first language and at least a second image containing the same text as the first image written in a second language. The first image containing the text written in the first language is adapted to be viewed within a first viewing angle and the second image containing the same text as the first image in a second language is adapted to be viewed within a second viewing angle. The first viewing angle is different from the second viewing angle. The multi-lingual display system may be a holographic display generated via multi-channel holography or a multi-layered retroreflective display.

### CROSS REFERENCE TO RELATED CO-PENDING APPLICATIONS

This application claims the benefit of U.S. provisional application Serial No. 60/424036 filed on Nov. 5, 2002 and entitled MULTI-LINGUAL DISPLAY APPARATUS AND METHOD, the contents of which are expressly incorporated herein by reference.

### FIELD OF THE INVENTION

The present invention relates to a display apparatus and method, and more particularly to a multi-lingual display apparatus and method.

### BACKGROUND OF THE INVENTION

Space is a major constraint in the advertising and signage industry. Multiple images usually need to be displayed in a very small space. The images may include pictures and/or text. In a linguistically homogeneous society the text needs to be in a single language. However, in an increasingly global society, there is a need to display text messages in more than one language. In large cities around the world it is common to find people who live or visit that speak and understand only one of a diverse range of languages. In particular, in public transportation facilities there is a need to display public service information in more than one language. Usually, information is displayed simultaneously in two or more languages on static billboard type displays. However, due to space limitations the length of the text and the number of languages are limited.

Dynamic image displays, such as a television or a computer screen may display information in various languages. However, the multi-lingual information is not displayed simultaneously. Alternatively, multiple dynamic displays may simultaneously project information in multiple languages. However, they occupy too much space. There is a need for a low cost display that can project multi-lingual information without occupying a lot of space.

### SUMMARY OF THE INVENTION

In general, in one aspect, the invention features a multi-lingual display system having a first image and at least a second image. The first image includes a first text written in a first language and is adapted to be viewed within a first viewing angle. The second image includes a second text written in a second language and is adapted to be viewed within a second viewing angle. The first viewing angle is different from the second viewing angle.

Implementations of this aspect of the invention may include one or more of the following features. The first text may be the same as the second text. The first image may be superimposed or adjacent to the at least second image. The first image may be located on a first surface, the at least second image may be located on a second surface, and the first surface may be superimposed or adjacent to the second surface. The first and the at least second images may be located on a concave, convex, or flat surface. The first image and the at least second image may further include pictures. The pictures may also be different for the different viewing angles. Both the pictures and the written text may be multi-colored. The multi-lingual display system may include more than two images and each additional image may have text written in a language different from the languages of the other images and may be adapted to be viewed within a viewing angle different from the viewing angles of the other images. The multi-lingual display system may further include a holographic film, and the holographic film may store the first and the at least second images as first and second holograms, respectively. The first and second holograms may be generated via multi-channel holography. The first and second holograms may be edgelit holograms. The multi-lingual display system may further include a retroreflective display and-the retroreflective display may include the first and the at least second image. The multi-lingual display may further include a display made of plastic, paper, cardboard, fabric, metal, ceramic, or other materials suitable of being coated. The first and the at least second images may be static, dynamic or generated via a Central Processor Unit. The multi-lingual display may be a Liquid Crystal Display (LCD), a Cathode Ray Tube display, a plasma display or an optical polymer display. The first and second viewing angles may be color-coded. The first and the at least second images may include maps and schedules for public transportation, building directories, road signs, public service information, signage, or advertisements. The first and the at least second images may be two dimensional or three-dimensional. At least the first image may include an embedded holographic system (EHS) and the EHS may include a full-motion stereogram. The multi-lingual display system may be a 360-degree display.

In general, in another aspect the invention features a multi-lingual display system having a holographic film and the holographic film includes a first holographic image having text written in a first language and at least a second holographic image having text written in a second language. When the first and the at least second holographic images are illuminated they are adapted to be viewed within a first and a second viewing angles, respectively. The first viewing angle is different from the second viewing angle.

In general, in another aspect the invention features a multi-lingual display system having a display which when illuminated by a light source is adapted to present selectively to an observer images that depend on the angular position of the source and that of the observer relative to the display. The display includes a first layer, at least a second layer and a retroreflective layer. The first layer includes a first image having text written in a first language. The at least a second layer overlays the first layer and includes a second image having text written in a second language. The retroreflective layer overlays the at least second layer. When light rays from the light source incident to the retroreflective layer are reflected thereby, these reflected light rays depending upon the angular position of the source and that of the observer relative to the display, either pass through the first and the retroreflective layers and the observer will see the first image having the text written in the first language, or the light rays will pass through the at least second and the retroreflective layer and the observer will see the second image having the text written in the second language.

Implementations of this aspect of the invention may include one or more of the following features. The retroreflective layer may include beads or multi-faced indentations.

In general, in another aspect, the invention features a method of displaying written text in a first language and at least a second language. The method includes providing a display having a first image and at least a second image. The first image includes the text written in the first language and is adapted to be viewed within a first viewing angle. The at least second image includes the text written in the second language and is adapted to be viewed within a second viewing angle. The method further includes illuminating the display and projecting the first image comprising the text written in the first language within the first viewing angle and the at least second image comprising the text written in the second language within the second viewing angle.

In general, in another aspect, the invention features a multi-informational display system having a first image and at least a second image. The first image includes a first piece of information and is adapted to be viewed within a first viewing angle. The at least second image includes a second piece of information and is adapted to be viewed within a second viewing angle. The first viewing angle is different from the second viewing angle. The first image may include close-captioning or subtitles.

Among the advantages of this invention may be one or more of the following. The invention provides a display that displays simultaneously text written in more than one language while occupying space needed for text written only in one language. It offers a low cost solution for the signage, public service information, and advertising industries. The display has a large range of applications in a multi-lingual, and multi-cultural society. The images include text and pictures that are multi-colored, vibrant, and clear to the viewer. The method may be applied to generate multi-lingual books, multi-lingual greeting or other type of cards, multi-lingual posters, and multilingual Heads Up Displays (HUD) used in cars. In particular, for displays with text written in Mandarin or other Chinese dialects that extend vertically and usually occupy large surface area this method offers a solution that reduces the size of the display area.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

Referring to the figures, wherein like numerals represent like parts throughout the several views:

FIG. 1 is a cross sectional schematic diagram of a multi-lingual display of this invention;

FIG. 2 is a front view of the multi-lingual display of FIG. 1;

FIG. 3A is a diagrammatic view of the generation of a first image for a multi-lingual display utilizing multi-channel holography;

FIG. 3B is a diagrammatic view of the generation of a second image for a multi-lingual display utilizing multi-channel holography;

FIG. 3C is a diagrammatic view of the generation of a third image for a multi-lingual display utilizing multi-channel holography;

FIG. 4 is a cross sectional view of a multi-lingual display that utilizes retroreflectivity; and

FIG. 5 is a front view of a multi-information display of this invention.

### DETAILED DESCRIPTION OF THE INVENTION

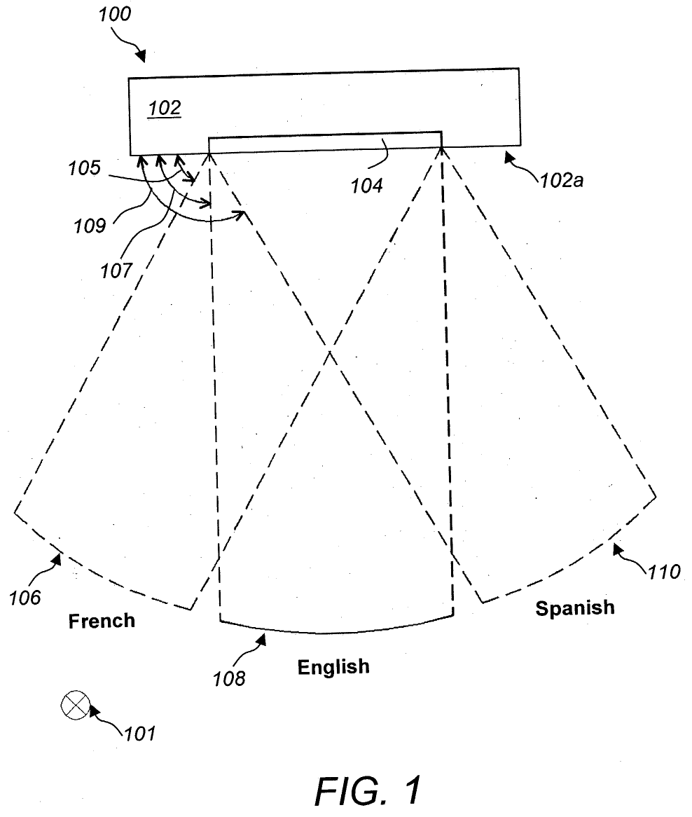

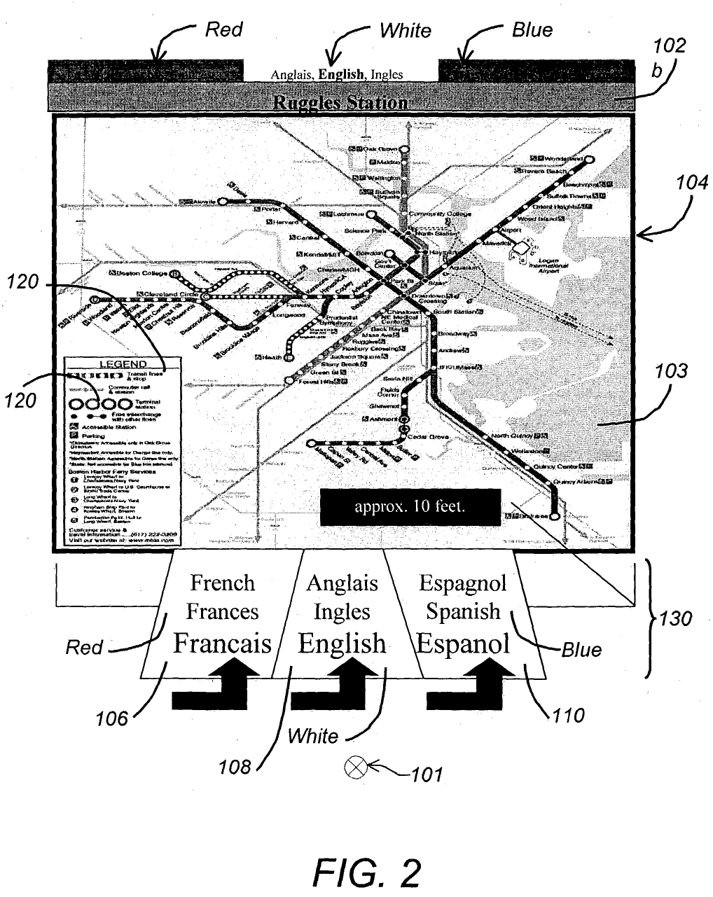

Referring to FIG. 1, a multi-lingual display system 100 includes a display board 102 having a multi-lingual image 104 on its front surface 102a. Multi-lingual image 104 includes a pictorial image 103 (shown in FIG. 2) and text 120 written in French 106, English 108 and Spanish 110. An observer 101 views the French text 106, the English text 108, and the Spanish text 110 when he stands within the viewing angle 105, 107, and 109 respectively. Viewing angles 105, 107 and 109 are measured from the front surface 102a of the display 102. In the embodiment of FIG. 2, the pictorial image 103 is a railroad map and the written text 120 contains information about the various train lines, names of train stops, train schedules and fares, customer service contact phone numbers, and explanations of symbols used in the map, among others. The observer 101 views the above mentioned information in French 106, English 108, and Spanish 110 when he stands in front of the display 102 at angles 105, 107, and 109, respectively. In one example, angles 105, 107 and 109 have values of 45°, 90° and 135°. Angle 105 may take values between 0° and 60°, angle 107 may be in the range between 60° and 120°, and angle 109 may be in the range between 120° and 180°. Viewing angles 105, 107, and 109 are marked and color-coded on top of the display 102b, and the floor below the display 130, shown in FIG. 2. According to the color-coding scheme of this example a viewer 101 standing in the red zone views the text in French 106, in the white zone views the text in English 108, and in the blue zone views the text in Spanish 110.

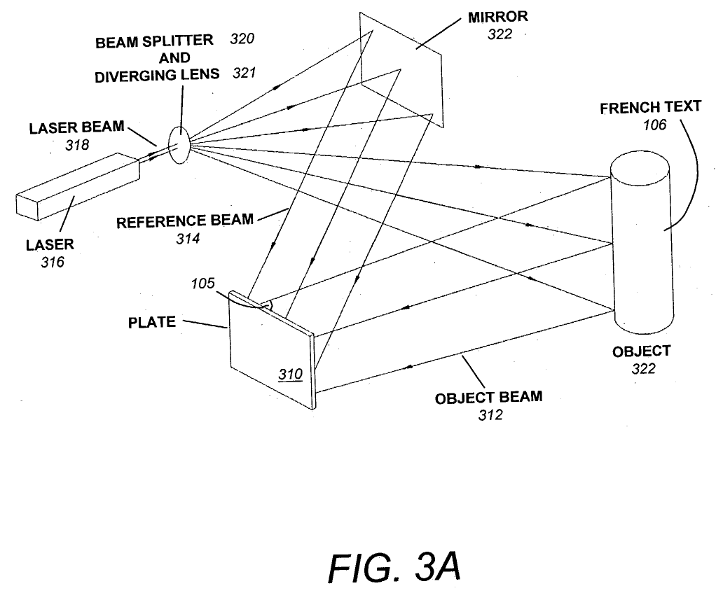

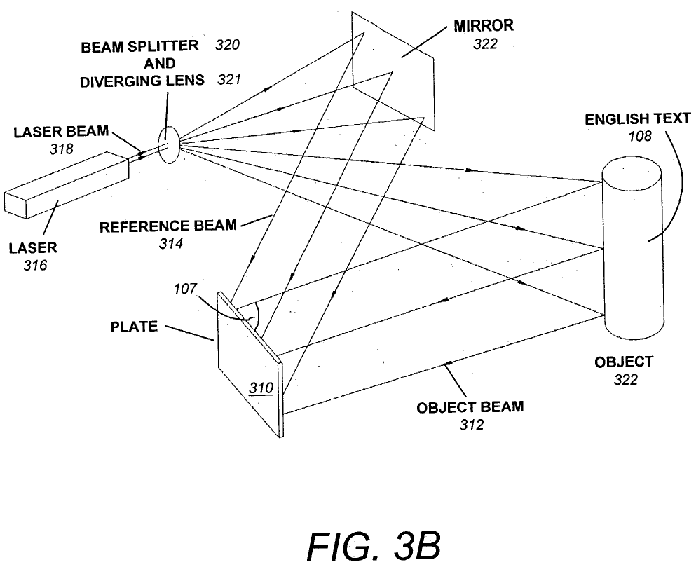

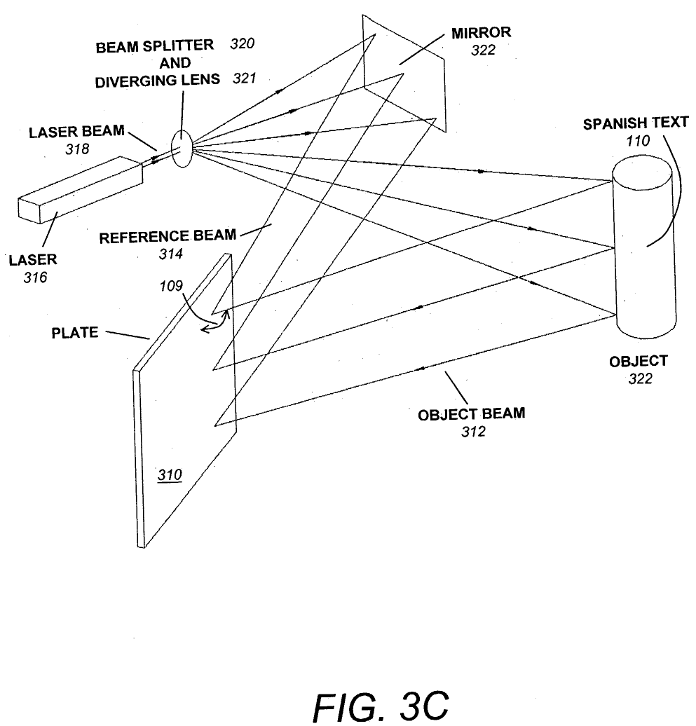

Referring to FIG. 3A, FIG. 3B, and FIG. 3C, the multi-lingual image 104 is a holographic image, which is generated utilizing multi-channel holography. Holograms are well known in the art and are described in many books and publications. One such book is entitled “The Hologram Book” by J. E. Kasper and S. A. Feller, the entire content of which is incorporated herein by reference. A hologram is basically a photographic emulsion 310 in which an image is stored as an interference of two beams of coherent light, the object beam 312, and the reference beam 314. A laser 316 generates a coherent light beam 318, which is split by a beam splitter 320 into an object beam 312 and a reference beam 314. Diverging lenses 321 broaden both the reference beam 314 and the object beam 312. The reference beam 314 is reflected off a mirror 322 onto the holographic emulsion 310 where it interferes with the object beam 312, which is reflected off the object 322. In a multi-channel hologram multiple images are recorded in one reflection hologram. A multi-channel hologram is generated by exposing a first image on the photographic emulsion 310 and then rotating the photographic emulsion 310 and exposing a second image. Each image is viewed at a different viewing angle, which is the same as the recording angle. In the embodiment of FIG. 3A a first holographic image of a text written in French 106 is projected and recorded onto the photographic emulsion 310. The emulsion 310 is oriented at an angle 105 relative to the object beam 312. Next the photographic emulsion 310 is rotated to an angle position 107 relative to the object beam 312 and a second holographic image of the same text written in English 108 is projected and recorded onto the emulsion 310, as shown in FIG. 3B. Finally, the emulsion is rotated to an angle position 109 relative to the object beam 312 and a third holographic image of the same text written in Spanish 110 is projected and recorded onto the emulsion 310, as shown in FIG. 3C.

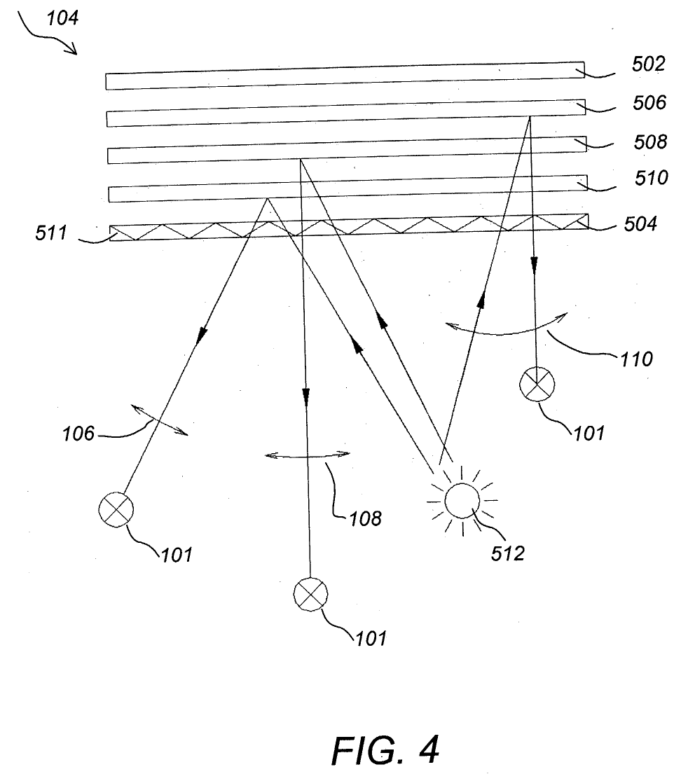

In another embodiment of this invention, the multi-lingual image 104 is generated utilizing retroreflectivity. A multi-image retroreflective display is described in U.S. Pat. No. 5,624,731, the entire content of which is incorporated herein by reference. The retroreflective display of U.S. Pat. No. 5,624,731 provides a multi-image display which when illuminated by a light source presents selectively to an observer images that depend on the angular position of the light source and the observer. Referring to FIG. 4, the multi-lingual image 104, includes a substrate 502 formed of plastic, metal, fabric, paper, cardboard or other suitable material capable of being coated. Coated on substrate 502 are image layers 506, 508 and 510 having images containing pictures and text written in French, English and Spanish, respectively. Finally, the top layer 504 coated on top of image layer 510 is a retroreflective layer. Retroreflective layer 504 is formed by a transparent plastic sheet having indentations 511. The multi-lingual image 104 is illuminated by a light source 512. When the observer 101 is positioned in angular range 106 he receives light reflected off image layer 510, which contains text written in French. When the observer 101 is positioned in angular range 108 he receives light reflected off image 508, which contains text written in English. When the observer 101 is positioned in angular range 110 he receives light reflected off image 506, which contains text written in Spanish.

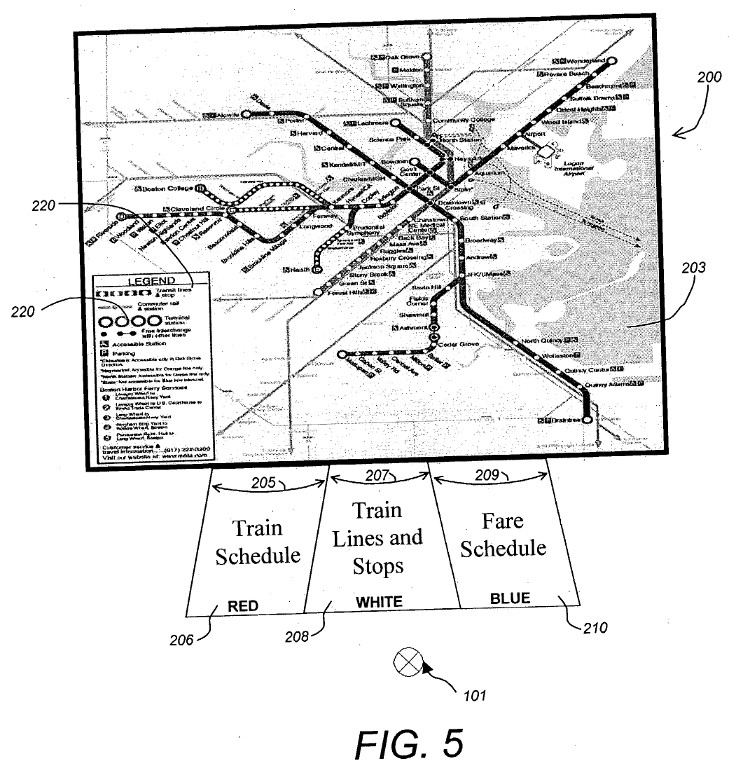

In the embodiment of FIG. 5 a multi-image display is utilized to produce a multi-informational display system 200. Referring to FIG. 5, a multi-informational display 200 includes a display board (not shown) having a multi-informational image 204 attached on its front surface 102a. Multi-informational image 104 includes a pictorial image 203 and text 220 grouped according to content. In the example of FIG. 5, a first text group contains the various train schedules 206, a second text group contains the names of train lines and stations, and a third text group contains the fare schedules. An observer 101 views the train schedule 206, the names of train lines and stations 208, and the train schedule text 210 when he stands within the viewing angle 205, 207, and 209 respectively. Angle 205 may take values between 0° and 60°, angle 207 may be in the range between 60° and 120°, and angle 209 may be in the range between 120° and 180°.

Other embodiments are within the scope of the following claims. For example, more than two images may be included, and each additional image may have text written in a language different from the languages of the other images and is adapted to be viewed within a viewing angle different from the viewing angles of the other images. Each language may have a plurality of representations on the display, i.e., may be displayed in more than one viewing angles. In one example, text written in English appears within every five degrees of viewing angle, so that it appears five times or more. The images may be static or dynamic. Dynamic images may be generated and changed via a Central Processor Unit (CPU). Dynamic images may be displayed via Liquid Crystal Displays (LCD), Cathode Ray Tube (CRT) displays, or plasma displays, among others. The images may be holograms, and in particular edgelit holograms. Hardcopy holography provides a method for displaying three-dimensional information in a manageable two-dimensional form. However, current hologram types require strict control of ambient lighting in the display area to correctly replay imagery. This fact has hindered the development of holography as a tool for visualization. Unlike the standard transmission and reflection types, edgelit holograms are not susceptible to blurring from extraneous light in the viewing environment. This allows the edgelit to be displayed in well-lit areas with little regard for other light sources such as fluorescent panels. An edgelit hologram is illuminated at a very steep angle by a light source positioned nearby and the light is introduced through the edge of the hologram and directed onto it. Edgelit holograms are described in “Edgelit Holography: Extended Size and Color” by Ryder Nesbitt, S. M. Thesis, Massachusetts Institute of Technology, (1999), incorporated herein by reference. The edgelit holograms may be displayed on static, dynamic or moving displays. In one example a moving display is a moving vehicle that includes the display on its body. In addition to written text the images may include pictures. The pictures may also be different for the different viewing angles. Both the pictures and the written text may be multi-colored. The various viewing angles displaying the various images may be marked and coded using different colors. A viewer uses the color-coded scheme to stand in the range of the appropriate viewing angle to observe the image containing the text written in the language of his preference or to view a specific type of information. The multi-lingual displays of this invention have applications in the signage, public service information and advertising industries. In particular, they may be used in displaying multi-lingual information in transportation including trains, buses, airlines, building directories, and road signs among others. In cases where close-caption or subtitles are needed one of the viewing angles may have the captioning or the subtitles and another may be without it. The holographic display may be two-dimensional or a stereoscopic three-dimensional display. In one example the display is a 360-degree display manufactured by C-360 Inc., of Rhode Island. The 360-degree display allows viewers to see images from any position within the 360-degree perimeter of the display. In another example the display is slightly curved or panoramic to increase the viewable area. At least one of the images may include an embedded holographic system (EHS). The EHS may be embedded into the multi-channel hologram and may include a full-motion stereogram that shows direction or other motion details that may clarify the textual commentary. The stereogram may be viewable within a smaller viewing angle than the viewing angle of each language. The multi-lingual display may comply with the International Organization for Standardization (ISO) signage standards. The method may be applied to generate multi-lingual books, multi-lingual greeting or other type of cards, multi-lingual posters, and multilingual Heads Up Displays (HUD) used in cars.

Several embodiments of the present invention have been described. Nevertheless, it will be understood that various modifications may be made without departing from the spirit and scope of the invention. Accordingly, other embodiments are within the scope of the following claims.

What is claimed is:

1. A multi-lingual display system comprising:
a first image wherein said first image comprises a first text written in a first language and is adapted to be viewed within a first viewing angle;
at least a second image wherein said at least second image comprises a second text written in a second language and is adapted to be viewed within a second viewing angle; and
wherein said first viewing angle is different from said second viewing angle.

2. The multi-lingual display system of claim 1 wherein said first image is superimposed onto said at least second image.

3. The multi-lingual display system of claim 1 wherein said first image is adjacent to said at least second image.

4. The multi-lingual display system of claim 1 wherein said first image is located on a first surface, said at least second image is located on a second surface, and said first surface is superimposed onto said second surface.

5. The multi-lingual display system of claim 1 wherein said first image is located on a first surface, said at least second image is located on a second surface, and said first surface is adjacent to said second surface.

6. The multi-lingual display system of claim 1 wherein said first text is the same as said second text.

7. The multi-lingual display system of claim 1 wherein said first and said at least second images are located on a concave surface.

8. The multi-lingual display system of claim 1 wherein said first and said at least second images are located on a convex surface.

9. The multi-lingual display system of claim 1 wherein said first and said at least second images are located on a flat surface.

10. The multi-lingual display system of claim 1 wherein at least said first image further comprises a picture.

11. The multi-lingual display system of claim 1 comprising more than two images wherein each additional image has text written in a language different from the languages of the other images and is adapted to be viewed within a viewing angle different from the viewing angles of the other images.

12. The multi-lingual display system of claim 1 further comprising a holographic film, wherein said holographic film stores said first and said at least second images as first and second holograms, respectively.

13. The multi-lingual display system of claim 12 wherein said first and second holograms are generated via multi-channel holography.

14. The multi-lingual display system of claim 12 wherein said first and second holograms are edgelit holograms.

15. A multi-lingual display system comprising a holographic film said holographic film comprising a first holographic image having text written in a first language and at least a second holographic image having said text written in a second language and wherein said first and said at least second holographic images when illuminated are adapted to be viewed within a first and a second viewing angles, respectively, wherein said first viewing angle is different from said second viewing angle.

16. The multi-lingual display system of claim 1 further comprising a retroreflective display wherein said retroreflective display comprises said first and said at least second images.

17. A multi-lingual display system comprising a display which when illuminated by a light source is adapted to present selectively to an observer images that depend on the angular position of the source and that of the observer relative to the display, said display comprising:
a first layer comprising a first image having text written in a first language;
at least a second layer overlaying said first layer comprising a second image having said text written in a second language;
a retroreflective layer overlaying said at least second layer; and
wherein when light rays from said light source incident to said retroreflective layer are reflected thereby, these reflected light rays depending upon said angular position of the source and that of the observer relative to the display, either pass through said first and said retroreflective layers and the observer will see said first image having said text written in said first language, or the light rays will pass through said at least second and said retroreflective layer and the observer will see said second image having said text written in said second language.

18. The multi-lingual display system of claim 17 wherein said retroreflective layer comprises beads.

19. The multi-lingual display system of claim 17 wherein said retroreflective layer comprises multi-faced indentations.

20. The multi-lingual display system of claim 1 further comprising a display made of a material selected from a group consisting of plastic, paper, cardboard, fabric, metal, ceramic, and other materials suitable of being coated.

21. The multi-lingual display system of claim 1 wherein said first and said at least second images are static.

22. The multi-lingual display system of claim 1 wherein said first and said at least second images are dynamic.

23. The multi-lingual display system of claim 1 wherein said first and said at least second images are generated via a Central Processor Unit.

24. The multi-lingual display system of claim 1 comprising a display selected from a group consisting of Liquid Crystal Display (LCD), Cathode Ray Tube display, plasma display and optical polymer display.

25. The multi-lingual display system of claim 1 wherein said first and second viewing angles are color-coded.

26. The multi-lingual display system of claim 1 wherein said first and said at least second images comprise information selected from a group consisting of maps and schedules for public transportation, building directories, road signs, public service information, signage, and advertisements.

27. The multi-lingual display system of claim 1 wherein said first and said at least second images are two-dimensional.

28. The multi-lingual display system of claim 1 wherein said first and said at least second images are three-dimensional.

29. The multi-lingual display system of claim 1 further comprising a 360-degree display said display comprising said images.

30. The multi-lingual display system of claim 1 wherein at least said first image comprises an embedded holographic system (EHS), said EHS comprising a full-motion stereogram.

31. A method of displaying written text in a first language and at least a second language comprising:
providing a display comprising a first image and at least a second image wherein said first image comprises said written text in said first language and is adapted to be viewed within a first viewing angle and said at least second image comprises said written text in said second language and is adapted to be viewed within a second viewing angle; and
illuminating said display and projecting said first image comprising said written text in said first language within said first viewing angle and said at least second image comprising said written text in said second language within said second viewing angle.

32. The method of claim 31 wherein said first image is superimposed onto said at least second image.

33. The method of claim 31 wherein said first image is adjacent to said at least second image.

34. The method of claim 31 wherein said first image is located on a first surface, said at least second image is located on a second surface, and said first surface is superimposed onto said second surface.

35. The method of claim 31 wherein said first image is located on a first surface, said at least second image is located on a second surface, and said first surface is adjacent to said second surface.

36. The method of claim 31 wherein said first text is the same as said second text.

37. The method of claim 31 wherein said first and said at least second images are located on a concave surface.

38. The method of claim 31 wherein said first and said at least second images are located on a convex surface.

39. The method of claim 31 wherein said first and said at least second images are located on a flat surface.

40. The method of claim 31 wherein at least said first image further comprises a picture.

41. The method of claim 31 wherein said first and said at least second images comprise first and second holograms, respectively.

42. The method of claim 31 wherein said first and second holograms are generated via multi-channel holography.

43. The method of claim 31 wherein said first and second holograms are edgelit holograms

44. A method of displaying written text in at least a first language and at least a second language comprising:
providing a display comprising a holographic film said holographic film comprising a first holographic image having text written in a first language and at least a second holographic image having said text written in a second language and wherein said first and said at least second holographic images when illuminated are adapted to be viewed within a first and a second viewing angles, respectively; and
illuminating said display and projecting said first holographic image comprising said written text in said first language within said first viewing angle and said at least second holographic image comprising said written text in said second language within said second viewing angle

45. The method of claim 31 wherein said display is a retroreflective display.

46. A method of displaying written text in a first language and at least a second language comprising:
providing a display which when illuminated by a light source is adapted to present selectively to an observer images that depend on the angular position of the source and that of the observer relative to the display said display comprising a first layer comprising a first image having text written in said first language; at least a second layer overlaying said first layer comprising a second image having said text written in said at least second language; and a retroreflective layer overlaying said at least second layer; and
illuminating said display with said light source whereby light rays from said light source incident to said retroreflective layer are reflected thereby, these reflected light rays depending upon said angular position of the source and that of the observer relative to the display, either pass through said first and said retroreflective layers and the observer will see said first image having said text written in said first language, or the light rays will pass through said at least second and said retroreflective layers and the observer will see said second image having said text written in said at least second language.

47. The method of claim 46 wherein said retroreflective layer comprises beads.

48. The method of claim 46 wherein said retroreflective layer comprises multi-faced indentations.

49. The method of claim 31 wherein said display is made of a material selected from a group consisting of plastic, paper, cardboard, fabric, metal, ceramic, and other materials suitable of being coated.

50. The method of claim 31 wherein said display comprises more than two images wherein each additional image has text written in a language different from the languages of the other images and is adapted to be viewed within a viewing angle different from the viewing angles of the other images.

51. The method of claim 31 wherein said first and said at least second images are static.

52. The method of claim 31 wherein said first and said at least second images are dynamic.

53. The method of claim 31 wherein said first and said at least second images are generated via a Central Processor Unit.

54. The method of claim 31 wherein said display is selected from a group consisting of Liquid Crystal Display (LCD), Cathode Ray Tube display, plasma display and optical polymer display.

55. The method of claim 31 wherein said first and second viewing angles are color-coded.

56. The method of claim 31 wherein said first and said at least second images comprise information selected from a group consisting of maps and schedules for public transportation, building directories, road signs, public service information, signage, and advertisements.

57. The method of claim 31 wherein said display is two-dimensional.

58. The method of claim 31 wherein said display is three-dimensional.

59. The method of claim 31 wherein said display is a 360-degree display.

60. The method of claim 31 wherein at least said first image comprises an embedded holographic system (EHS), said EHS comprising a full-motion stereogram.

61. A multi-informational display system comprising:
a first image wherein said first image comprises a first piece of information and is adapted to be viewed within a first viewing angle;
at least a second image wherein said at least second image comprises a second piece of information and is adapted to be viewed within a second viewing angle; and
wherein said first viewing angle is different from said second viewing angle.

62. The multi-informational display system of claim 61 wherein said first image comprises close-captioning or subtitles.
